(19) United States
(12) Patent Application Publication
(10) Pub. No.: US 2007/0186864 A1
(43) Pub. Date: Aug. 16, 2007

(54) Hatching apparatus for learners

(76) Inventor: Jong-Yoon Bae, Gyeoungsunynam-do (KR)

Correspondence Address: DEFILLO & ASSOCIATES, INC., P.O. Box 14104, Clearwater, FL, 33766, US

(21) Appl. No.: 11/659,380

(22) PCT Filed: Nov. 17, 2005
(86) PCT No.: PCT/KR05/03896

§ 371 Date: Feb. 5, 2007

(30) Foreign Application Priority Data
Nov. 17, 2004 (KR) 20-2004-0032555

(51) Int. Cl. A01K 41/04

(52) U.S. Cl. 119/319

(57) ABSTRACT

Disclosed is a hatching apparatus for learners enabling observation of a hatching process of a hatching egg. The hatching apparatus for learners is provided with a hatching chamber that defines a hatching space suitable for accommodation of a hatching egg and has a viewing window. As for a hatching condition in the hatching chamber, temperature and humidity in the hatching chamber are controlled by introducing air heated by a heater and moisture generated through vaporization of water by means of a fan into the hatching chamber. The hatching egg seated in the hatching chamber is turned by an egg-turning device. The egg-turning device, the heater and the fan are controlled by a control unit, so that the temperature and humidity in the hatching chamber can be consistently maintained and the hatching egg can be periodically turned.

### TECHNICAL FIELD

The present invention relates a hatching apparatus capable of automatically controlling a hatching condition for a hatching egg, and more particularly, to a hatching apparatus for learners, which enables observation of a hatching process of a hatching egg.

### BACKGROUND ART

Generally, in order to hatch various kinds of hatching eggs, a hatching condition in a hatching space should be maintained uniformly. To uniformly maintain a hatching condition, an artificial hatching apparatus including an electric bulb and a thermometer has been used. The artificial hatching apparatus monitors temperature in a hatching space through a thermometer and periodically turns on/off the electric bulb for heating air in the hatching space. Since the artificial hatching apparatus relies on the temperature monitoring through the thermometer in such a way, it has difficulty in uniformly maintaining the temperature in the hatching space. In addition, since the electric bulb heats an upper air layer in the hatching space, it is difficult to make a circulation between the upper air layer and a lower air layer in the hatching space. This inevitably causes severe difference in temperature between the upper air layer and the lower air layer in the artificial hatching apparatus. As a result, a hatching egg cannot be hatched on an expected date in the artificial hatching apparatus using the electric bulb and the thermometer.

Further, for massive hatching of hatching eggs, a large-size artificial hatching apparatus has been manufactured. Therefore, such a conventional artificial hatching apparatus inevitably has a large volume and heavy weight and is expensive as well. Thus, it is difficult for the conventional artificial hatching apparatus to be installed for learners at home or school.

As a solution for dealing with such a problem, there has been proposed a box-shaped hatching apparatus for learners, wherein a viewing window is provided in a side surface thereof. Since this hatching apparatus for learners also uses an electric bulb to heat air in a hatching space, it is difficult to uniformly maintain a hatching condition. Moreover, in the conventional hatching apparatus, a circulation fan continues to operate even when a door of the hatching apparatus is opened, resulting in sudden decrease in the temperature of a hatching space due to external cold air from the outside. Therefore, the mortality of a hatching egg inevitably increases in the conventional hatching apparatus for learners. Furthermore, since the conventional hatching apparatus has a complicated inner structure, it is difficult to manufacture the hatching apparatus and production costs increase. In addition, the conventional hatching apparatus for learners causes inconvenience to users in that when a hatching egg has been hatched, a newly-born chick should be moved to another place.

Furthermore, in order to ensure normal hatching of a hatching egg, the hatching egg should be rolled at a certain interval. However, the conventional hatching apparatus for learners is not provided with a proper means for rolling a hatching egg. This inevitably lowers the hatching rate of a hatching egg in the conventional hatching apparatus for learners.

Further, the conventional hatching apparatus for learners is not provided with a proper means for detecting whether a hatching egg undergoing a hatching process is alive or dead. Thus, in the conventional hatching apparatus for learners, there are many cases where a dead hatching egg is observed. As a result, the conventional hatching apparatus for learners has remarkably lowered effects on learning of the hatching of a hatching egg.

### DISCLOSURE

Technical Problem

Accordingly, an object of the present invention is to provide a hatching apparatus for learners, which is adapted to maximize effects on learning of a hatching process of a hatching egg.

Another object of the present invention is to provide a hatching apparatus for learners, which is adapted to improve the hatching rate of a hatching egg.

A further object of the present invention is to provide a hatching apparatus for learners, which is adapted to optimally maintain a hatching condition for a hatching egg.

A still further object of the present invention is to provide a hatching apparatus for learners, which is adapted to inform whether a hatching egg undergoing a hatching process, is alive or dead.

Technical Solution

According to an aspect of the present invention for achieving the objects, there is provided a hatching apparatus for learners, comprising a hatching chamber defining a hatching space suitable for accommodation of a hatching egg and having a viewing window; a hatching control means for controlling a hatching condition in the hatching chamber; an egg-turning device for turning the hatching egg seated within the hatching chamber; and a control unit for controlling the egg-turning device and the hatching control means to consistently maintain the hatching condition and to periodically drive the egg-turning device.

The egg-turning device may comprise a roller provided to be rotatable in contact with the hatching egg seated in the hatching chamber; and a motor for rotating the roller.

The egg-turning device may further comprise a power transmission unit for transmitting a rotational force generated by the motor to the roller.

The hatching apparatus may further comprise a display unit for displaying the hatching condition of the hatching egg under control of the control unit.

The hatching apparatus may further comprise an input device for sending information on the kind of hatching egg to be hatched from a user to the control unit.

The hatching apparatus may further comprise a state-detecting unit for detecting the state of the hatching egg undergoing a hatching process in the hatching chamber and providing the detected state to the control unit. In this case, the display unit may display the detected state of the hatching egg under the control of the control unit.

The hatching apparatus may further comprise a lamp for illuminating the interior of the hatching chamber under the control of the control unit.

The hatching chamber preferably comprises a hatching egg-seating recess having a curved surface suitable for seating of the hatching egg therein; and a through-hole formed at the center of the hatching egg-seating recess so that a portion of the roller can be exposed therethrough.

The hatching control means may comprise a temperature sensor for detecting temperature in the hatching chamber and providing the detected temperature to the control unit; an electric heater operated under the control of the control unit; a water-storing part for storing water for use in adjusting humidity in the hatching chamber; and a fan operated under the control of the control unit to vaporize the water stored in the water-storing part and to introduce the vaporized moisture and air heated by the electric heater into the hatching chamber.

The hatching apparatus may further comprise a fluid quantity sensor for detecting the quantity of the water stored in the water-storing part and providing the detected quantity of the water to the control unit. In this case, the control unit may control a water replenishment request symbol on the display unit, based on the quantity of the water detected by the fluid quantity sensor.

The hatching apparatus may further comprise an opening/closing switch performing switching according to opening or closing of the viewing window. Then, the control unit may control the electric heater and a viewing window-opening/closing symbol on the display unit in response to the switched state of the opening/closing switch.

Advantageous Effects

With such a constitution, the hatching apparatus for learners according to an embodiment of the present invention not only enables observation of a hatching process of a hatching egg but also maximizes effects on the observation of hatching of a hatching egg. Further, the hatching apparatus for learners according to an embodiment of the present invention can improve a hatching rate of a hatching egg and also prevent death of a hatching egg due to cold external air.

### DESCRIPTION OF DRAWINGS

The above and other objects, features and advantages of the present invention will become apparent from the following detailed description of a preferred embodiment given in conjunction with the accompanying drawings. To help better understanding of the drawings used in the detailed description, brief descriptions of the respective drawings will be provided below.

FIG. 1 is a perspective view illustrating an external appearance of a hatching apparatus for learners according to an embodiment of the present invention.

FIG. 2 is a perspective view illustrating a state where a door of the hatching apparatus for learners shown in FIG. 1 is opened.

FIG. 3 is an exploded perspective view illustrating the configuration of the hatching apparatus for learners shown in FIG. 1.

FIG. 4 is a bottom view illustrating a bottom surface of the hatching apparatus for learners shown in FIG. 1.

FIG. 5 is a plan view illustrating a lower support case of the hatching apparatus for learners shown in FIG. 1.

FIG. 6 is a front sectional view illustrating a section of the hatching apparatus for learners shown in FIG. 1, which is taken such that the apparatus is divided in a fore and aft direction.

FIG. 7 is a side sectional view illustrating a section of the hatching apparatus for learners shown in FIG. 1, which is taken such that the apparatus is divided in a lateral direction.

FIG. 8 is a view specifically illustrating a display unit 76 of the hatching apparatus for learners shown in FIG. 1.

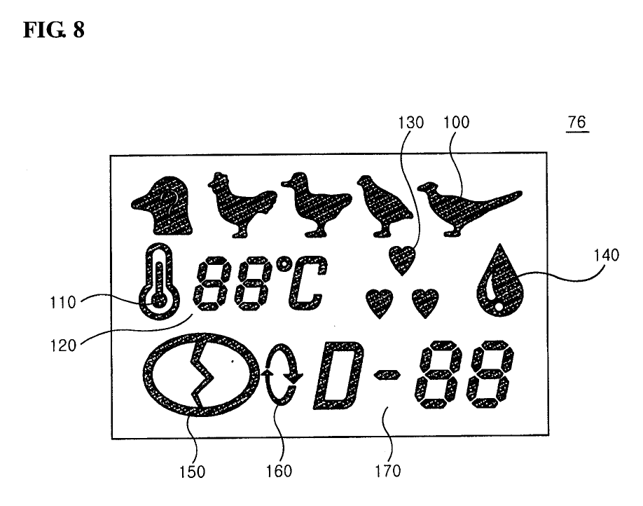

FIG. 9 is a block diagram schematically illustrating a control circuit included in the hatching apparatus for learners according to the embodiment of the present invention.

### BEST MODE

Hereinafter, a hatching apparatus for learners according to a preferred embodiment of the present invention will be described in detail with reference to the accompanying drawings.

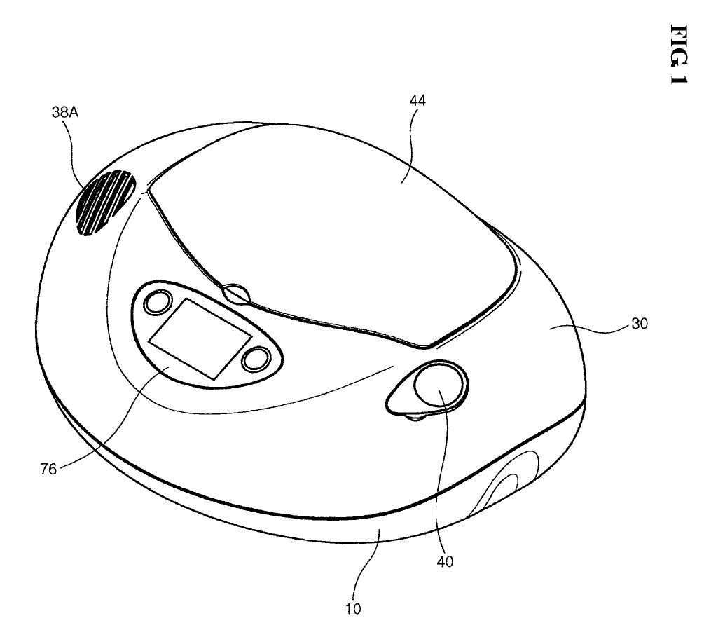

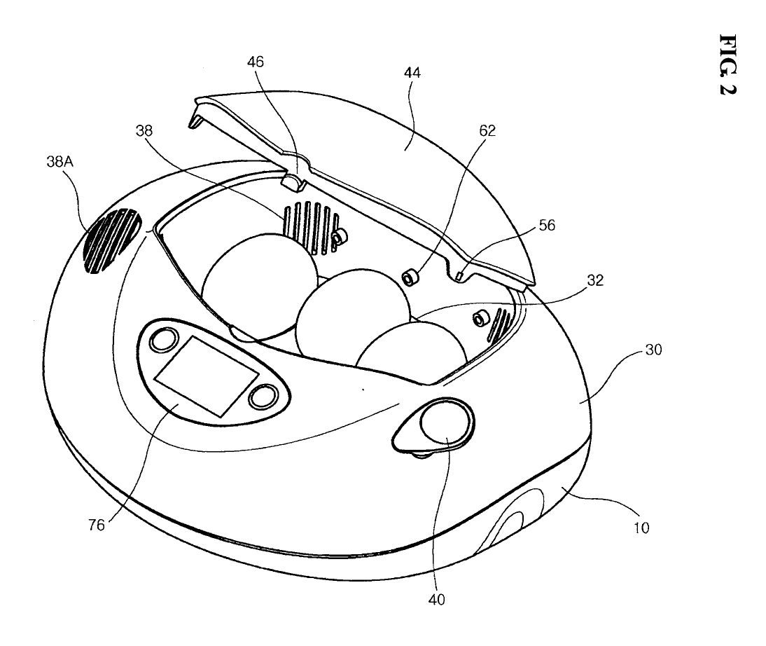

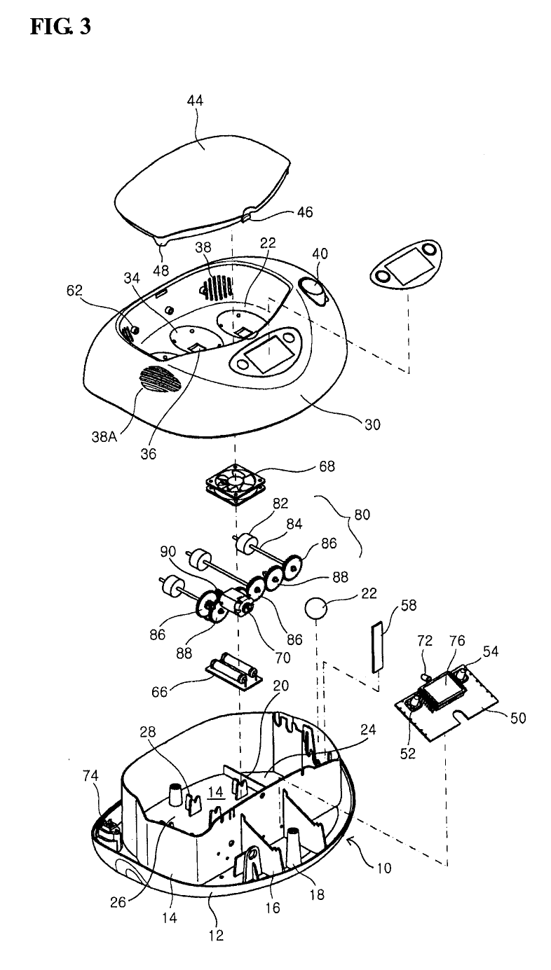

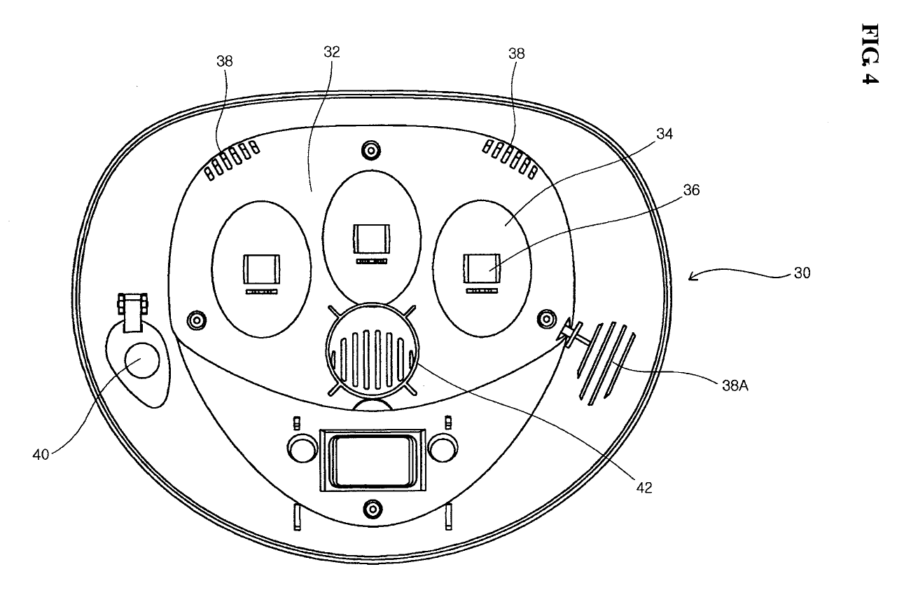

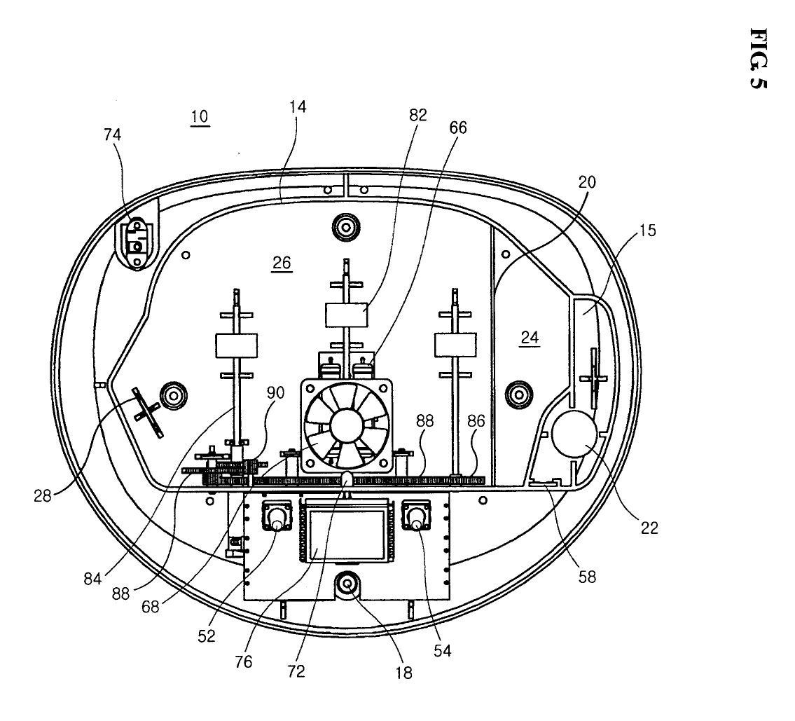

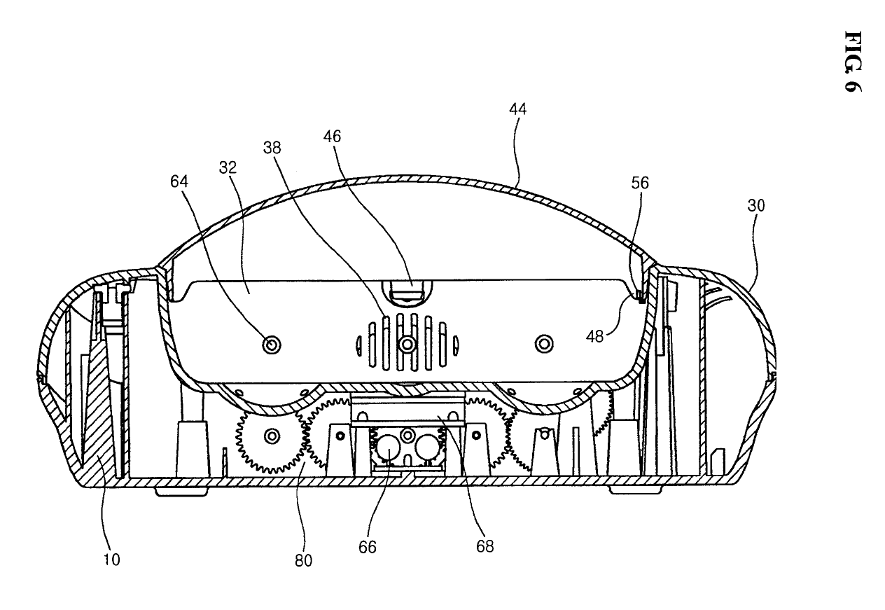

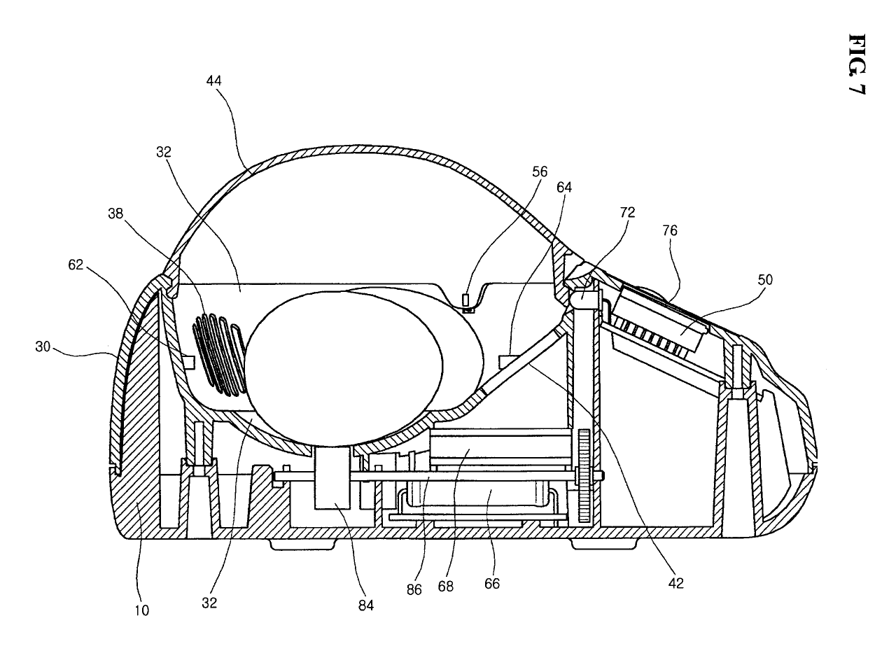

FIG. 1 is a perspective view illustrating an external appearance of a hatching apparatus for learners according to an embodiment of the present invention, FIG. 2 is a perspective view illustrating a state where a door of the hatching apparatus for learners shown in FIG. 1 is opened, FIG. 3 is an exploded perspective view illustrating the configuration of the hatching apparatus for learners shown in FIG. 1, FIG. 4 is a bottom view illustrating a bottom surface of the hatching apparatus for learners shown in FIG. 1, FIG. 5 is a plan view illustrating a lower support case of the hatching apparatus for learners shown in FIG. 1, FIG. 6 is a front sectional view illustrating a section of the hatching apparatus for learners shown in FIG. 1, which is taken such that the apparatus is divided in a fore and aft direction, and FIG. 7 is a side sectional view illustrating a section of the hatching apparatus for learners shown in FIG. 1, which is taken such that the apparatus is divided in a lateral direction. The mechanical constitution of the hatching apparatus for learners according to the embodiment of the present invention will be first described with reference to FIGS. 1 to 7.

Referring to FIGS. 1 to 7, the hatching apparatus for learners according to the preferred embodiment of the present invention comprises a hatching main body 30 mounted on a lower support case 10. The lower support case 10 comprises a rim 12 with small height defining an elliptical closed loop, and a support frame 14 positioned inside the rim 12 to support the hatching main body 30. Preferably, the support frame 14 vertically extends sufficiently beyond the rim 12. A front surface of the support frame 14 is formed with support members 16 extending parallel at a predetermined interval so as to properly mount a control board 50 thereon. Upper ends of the support members 16 are formed to be slanted so that the control board 50 with a display unit 76 mounted thereon can be slantly mounted. A fixing rod 18 is formed between the support members 16. The fixing rod 18 prevents play of the control board 50 slantly mounted in the support members 16. Further, a partition 20 for dividing a space defined by the support frame 14 is formed inside the support frame 14. A water-feeding port 22 is formed in a side surface of the support frame 14, which surrounds one of subspaces of the space divided by the partition 20. Water for use in properly adjusting humidity is stored in the subspace (hereinafter, referred to as a “water-storing part”) 24 of the space divided by the partition 20 where the water-feeding port 22 is provided. A variety of hatching controlling devices are installed in the other subspace (hereinafter, referred to as a “device-mounting part”) 26 of the space divided by the partition 20 where the water-feeding port 22 is not provided. The device-mounting part 26 is provided with holders 28 that secure a space with sufficient height for receiving the variety of hatching controlling devices.

The hatching main body 30 coupled with the lower support case 10 has a gently curved top surface to define a surface together with the rim 12 of the lower support case 10. Inside the top surface of the hatching main body 30, a hatching chamber 32 as a hatching space is provided above the support frame 14 of the lower support case 10. The display unit 76, a selection button 52 and a confirm button 52, which are mounted on the control board 50, are installed to be externally viewed at a central portion on a front face of the top surface of the hatching main body 30. The selection button 52 and the confirmation button 54 are exposed through the top surface of the hatching main body 30 so that they can be operated by a user or observer. An openable water-feeding cap 40 for use in replenishing water is provided at a side region on the top surface of the hatching main body 30.

The hatching chamber 32 has several hatching egg-seating recesses 34 at a rear portion on a floor surface thereof. The hatching egg-seating recesses are formed concavely to conform to the shape of hatching eggs such that the hatching eggs to be hatched can be stably and horizontally seated therein. Rectangular through-holes 36 are formed at the centers of the hatching egg-seating recesses 34. A front portion on the floor surface of the hatching chamber 32 is formed slantly so that the hatching egg-seating recesses 34 can receive various kinds of hatching eggs with different curvatures therein. Vent holes 38 are provided at right and left side portions on a rear inner wall of the hatching chamber 32 and at the center on a front inner wall thereof. The vent holes 38 comprise a plurality of slots sequentially arranged in a horizontal direction. A cylindrical circulation passage 42 is provided at a front portion on the floor surface of the hatching chamber 32 so that warm air and water in the form of vapor can be introduced from the lower support case 10 into the hatching chamber 32. A temperature sensor is installed in any one of inner walls of the hatching chamber 32. The temperature sensor detects temperature in the hatching chamber 32 and transmits a signal corresponding to the detected temperature to a central processing unit (hereinafter, referred to as “CPU”) 78 mounted on the control board 50. The CPU 78 operates an electric heater 66 or an air circulation fan 68 in response to the temperature detection signal from the temperature sensor 60.

Moreover, infrared light-emitting units 62 are installed to correspond to the positions of hatching eggs to be seated in the hatching egg-seating recesses 34, at predetermined intervals between the vent holes 38 in the rear wall of the hatching chamber 32. Infrared light-receiving units 64 detect infrared modulated signals, which are outputted from the infrared light-emitting units 62 and transmitted through the hatching eggs undergoing a hatching process, and amplify and filter the detected, modulated signals to obtain information signals. The information signals obtained by the infrared light-receiving units 64 are supplied to the CPU 78 mounted on the control board 50. Based on the information signals from the infrared light-receiving units 64, the CPU 78 determines whether the hatching eggs are alive or dead, and causes the determined results to be displayed on the display unit 76. Specifically, when a week has passed after hatching was begun, blood vessels are developed in an embryo within a hatching egg and the flow rate of a blood stream is increased with heartbeats. In other words, as the embryo in the hatching egg grows up, the movement of the embryo actively occurs. Such variations in the flow rate of the blood stream change the amount of the infrared modulated signals transmitted through the hatching egg. Therefore, based on the information signals from the infrared light-receiving units 64, the CPU 78 detects changes in the transmitted amount of the infrared modulated signals, thereby determining whether the hatching egg undergoing the hatching process is alive or dead.

The hatching chamber 30 is provided with a door-type viewing window 44 pivotably installed at an upper end of the rear wall of the hatching chamber 32 so as to open or close the hatching chamber 32. The door-type viewing window 44 enables better observation of a hatching egg undergoing a hatching process within the hatching chamber 32 and simultaneously closes the hatching chamber 32 such that cold external air is not introduced thereinto. Further, a semicircular recess 46 is formed at the center of a front end of the door-type viewing window 44. This semicircular recess 46 allows the door-type viewing window 44 to be easily opened with a user's finger. Projection pieces 48 are formed at both side corners of a front portion on an inner surface of the door-type viewing window 42. These projection pieces 48 turn on or off opening/closing switches 56 for sensing an opened or closed state of the door-type viewing window 44. In other words, as the door-type viewing window 42 is opened or closed, the opening/closing switches 56 are turned on or off by means of the projection pieces 48 that come into contact therewith or are separated therefrom.

The electric heater 66 and the air circulation fan 68 are stacked on the floor of the device-mounting part 26 of the lower support case 10. The electric heater 66 heats air, and the air circulation fan 68 causes the warm air, which is heated by the electric heater 66, to be introduced into the hatching chamber 32 through the protruding cylindrical circulation passage 42 from a lower portion of the hatching main body 30. The air introduced into the hatching chamber 32 is exhausted to the outside through the vent holes 38 formed in the walls of the hatching chamber 32 and vent holes 38A formed at a left region on the top surface of the hatching main body 30, so that temperature in the hatching chamber 32 can be maintained at a temperature suitable for hatching of a hatching egg (e.g., 37 to 38° C.).

An egg-turning device 80 is installed above the electric heater 66. The egg-turning device 80 comprises rotating rollers 82 installed to protrude through the rectangular through-holes 36 of the respective hatching egg-seating recesses 34, pivoting shafts 84 extending from the respective rotating rollers 82, and count gears 86 installed at the other ends of the pivoting shafts 84 opposite to the rotating rollers 82. These count gears 86 are engaged with driven gears 88. Any one of the driven gears 88 and count gears 86 is engaged with a driving gear 90 installed on a rotational shaft of a driving motor 90. Therefore, the count gears 86 are rotated with the pivoting shafts 84 by means of a rotational force of the driving motor 70 transmitted from the driving gear 90 via the other count gears 86 and/or the driven gears 88, and thus, the rotating rollers 82 are rotated. Accordingly, hatching eggs seated respectively in the hatching egg-seating recesses 32 are turned (rolled). With the egg-turning device 80, the hatching eggs are turned (rolled) by 90 degrees at a time interval of three hours from a hatching starting date to three days before hatching completion, thereby improving the hatching rate of the hatching eggs. In fact, various kinds of hatching eggs have the following hatching periods: about twenty one (21) days in case of a chicken's egg, about twenty eight days (28) in case of a duck's egg, about twenty three days (23) in case of a pheasant's egg, and about seventeen days (17) in case of a quail's egg. Therefore, the driving period of the egg-turning device 80 is controlled properly according to the kind of hatching egg under the control of the CPU 78 of the control board 50. However, for other hatching eggs in addition to the aforementioned kinds of hatching eggs, the driving period may be controlled between one (1) day and forty (40) days.

In order to control humidity in the hatching chamber 32, the water-feeding cap 40 is provided on the hatching main body 30 to be connected to the water-feeding port 22 provided in the support frame 14 of the lower support case 10, and the water-storing part 24 is provided with a drain cap (not shown) extending downward. In addition, the water-storing part 24 has a fluid quantity sensor 58 at a side thereof (i.e., beside the water-feeding port 22). The fluid quantity sensor 58 detects the level of water stored in the water-storing part 24 and informs the CPU 78 of the control board 50 of the detected level of water. The CPU 78 of the control board 50 controls the water-feeding cap 40 and the drain cap based on the detection signal from the fluid quantity sensor 58 so that the quantity of water can be maintained consistently in the water-storing part 24.

The control board 50, which is slantly secured by the support members 16 and fixing rod 18 of the lower support case 10 such that it cannot be played, has the display unit 76 mounted on a top surface thereof. The display unit 76 is exposed to the outside through an opening of the hatching main body 30 so that a user can operate the display unit exposed through the opening of the hatching main body 30. The display unit 76 is provided with symbols 100 of birds (e.g., chicken, duck, pheasant, quail, and the like) according to the kinds of hatching eggs. These bird symbols 100 represent information on the kind of hatching egg selected by a user or observer. Further, below the bird symbols 100, the display unit 76 is provided with a symbol 110 for indicating whether the door-type viewing window 44 is opened or closed, a temperature-indicating region 110 for indicating the temperature in the hatching chamber 32, a region 130 for indicating the number of hatching eggs undergoing a hatching process, and a water replenishment warning symbol 140 for notifying replenishment of the water-storing part 24 with water. Moreover, in a lowermost row in the display unit 76, there are a survival-indicating region 150 for indicating whether a hatching egg undergoing a hatching process is alive or dead, an egg turning state indicating region 160 for indicating an egg turning state, and a remaining schedule indicating region 170 for indicating a remaining hatching schedule.

Backlights (not shown) are installed below the display unit 76. As a hatching state varies during hatching of a hatching egg, the backlights radiate light onto a symbol corresponding to the state so as to notify an observer or user of the current hatching state. The control board 50 further comprises the selection button 52 and the confirm button 52 installed at both sides of the display unit 76. The selection button 52 and the confirmation button 54 transmit pulse signals of specific logics to the CPU 78 whenever a user operates them. Whenever the CPU 78 receives a pulse signal of a specific logic from the selection button 52, it performs control to turn on or off the backlights such that the bird symbols 100 on the display unit 76 are sequentially and exclusively flickered. If a pulse signal of a specific logic is inputted from the confirmation button 54 when any one of the bird symbols 100 is flickered, the CPU 78 performs control to turn on or off the backlights such that the flickering bird symbol is continuously lighted. Thus, the CPU informs the user that the kind of hatching egg to be hatched has been set, and simultaneously sets the kind of hatching egg to be hatched and a hatching schedule. Further, the control board 50 further comprises a light-emitting diode lamp 72 installed at the rear of the display unit 76 to protrude into the hatching chamber 32. The light-emitting diode lamp 72 is turned on while a hatching egg is being hatched under the control of the CPU 78, thereby illuminating the hatching chamber 32. Accordingly, the observer can observe the hatching egg that undergoes a hatching process in the hatching chamber 32. The lower support case 10 has a buzzer 74 installed between a portion of the rim 12 corresponding to the water-feeding port 22 and the support frame 14. The buzzer 74 is driven by the CPU 78 to issue a warning sound. Specifically, the buzzer 74 issues a warning sound when the door-type viewing window 44 is opened, the water-storing part 24 lacks water, and the temperature in the hatching chamber 32 is a low temperature of not greater than 30° C. or a high temperature of not less than 40° C.

Mode for Invention

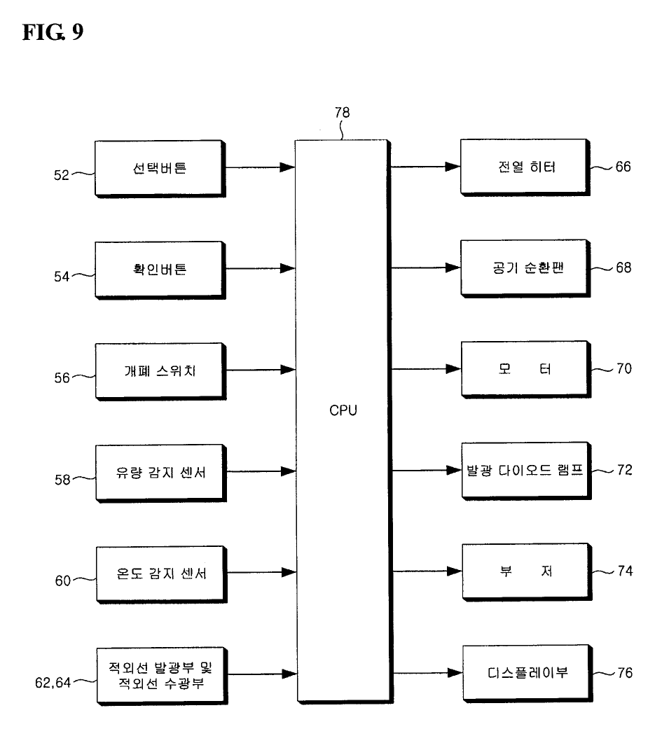

FIG. 9 is a block diagram schematically illustrating a control circuit included in the hatching apparatus for learners according to the embodiment of the present invention. Referring to FIG. 9, the control circuit of the hatching apparatus for learners comprises the selection button 52, the confirmation button 54, the opening/closing switches 56, the fluid quantity sensor 58, the temperature sensor 60, the infrared light-emitting and receiving units 62 and 64, the electric heater 66, the air circulation fan 68, the motor 70 for the egg-turning device 80, the light-emitting diode lamp 72, the buzzer 74, and the display unit 76, which are connected to the CPU 78. The CPU 78 controls the electric heater 66, the air circulation fan 68, the motor 70 for the egg-turning device 80, the light-emitting lamp 72, the buzzer 74 and the display unit 76 in response to signals from the selection button 52, the confirmation button 54, the opening/closing switches 56, the fluid quantity sensor 58, the temperature sensor 60, the infrared light-receiving unit 64. With the control of the CPU 78, the temperature and humidity in the hatching chamber 32 are maintained consistently and hatching eggs are turned (rolled) at predetermined time intervals for a proper period of time. In addition, the user or observer is informed of a state where a hatching egg to be hatched is selected, whether a hatching egg undergoing a hatching process is alive or dead, a state where the door-type viewing window 44 is opened or closed, a remaining hatching schedule, and the like. The control operation of the CPU 78 will be described in greater detail below.

First, when the door-type viewing window 44 is opened, the user or observer stably and horizontally places hatching eggs to be hatched within the hatching egg-seating recesses 34 of the hatching chamber 32. When the door-type viewing window 44 is closed by a user or observer, the CPU 78 recognizes the closed state of the door-type viewing window 44 based on the logical state of a signal applied from the opening/closing switches 56. Further, the CPU 78 can drive the buzzer 74 for a certain period of time so as to inform the user or observer that the door-type viewing window 44 has been normally closed. On the contrary, the CPU 78 may recognize that the door-type viewing window 44 has been opened based on the logical state of a signal from the opening/closing switches 56. Moreover, the CPU 78 continuously or intermittently drives the buzzer 74 for a certain period of time to issue a continuous or intermittent buzzer sound so that the user or observer can be informed of the opened state of the door-type viewing window 44.

When a pulse of a specific logic is inputted from the selection button 52, the CPU 78 controls the display unit 76 so that any one of the bird symbols 100 can be flickered. In addition, the CPU 78 enables changes in the bird symbols 100 to be flickered. For example, when a first pulse is inputted from the selection button 52, a first bird symbol 100 at the leftmost position is flickered. In response to a second pulse from the selection button 52, a second bird symbol 100 next to the first bird symbol is flickered. After a rightmost bird symbol 100 is flickered, the leftmost bird symbol 100 is again flickered. In such a manner, the CPU 78 controls the flickering of the bird symbols 100 of the display unit 76 in response to the pulse from the selection button 52. When a pulse is inputted from the confirmation button 54 while any one of the bird symbols 100 is flickered, the CPU 78 controls the display unit 76 such that the flickering bird symbol is continuously lighted, thereby informing the user or observer that the kind of hatching egg to be hatched has been selected. In addition, the CPU 76 sets the number of days, which is required for hatching (i.e., a hatching period) for the selected hatching egg, in a timer of the CPU, thereby setting a hatching mode for the selected hatching egg.

When the hatching mode for the selected hatching egg has been set, the CPU 78 turns on the light-emitting diode lamp 72 to illuminate the hatching chamber 32 until the hatching of the hatching egg is completed. Then, the hatching egg undergoing a hatching process within the hatching chamber 32 can be observed by the user or observer through the door-type viewing window 44. In addition, during a hatching period, the CPU 78 controls peripheral circuit elements to perform illuminating the hatching chamber 32, maintaining proper temperature and humidity in the hatching chamber 32, replenishing water required for uniform humidity in the hatching chamber 32, periodically turning (rolling) hatching eggs, informing the number of hatching eggs undergoing a hatching process and whether the hatching eggs are alive or dead, and informing a remaining hatching period. The control operation of the CPU 78 to be performed during the hatching period will be described in detail below.

To indicate a remaining hatching period, the timer included in the CPU 78 reduces the remaining hatching period, which has been set in the timer, in real time to count the remaining hatching period. The CPU 78 is informed of the remaining hatching period counted by the timer. The CPU 78 provides the display unit 76 with the remaining hatching period counted by the timer on a day basis, so that the remaining hatching period on the day basis is indicated in the display unit 76.

The CPU 78 drives the electric heater 66 and/or the air circulation fan 68 in response to a temperature sensing signal from the temperature sensor 60 installed in the hatching chamber 32 and a door-opening/closing sensing signal from the opening/closing switches 56, thereby controlling the temperature and humidity in the hatching chamber 32. The CPU 78 compares the temperature sensing signal from the temperature sensor 60 with a reference value corresponding to a reference hatching temperature (e.g., 38° C.) (hereinafter, referred to as a “reference hatching temperature value”) set in advance according to the kind of hatching egg, and determines whether the temperature in the hatching chamber 32 is lower than the reference hatching temperature value. Further, the CPU 78 checks the logical state of the door-opening/closing sensing signal from the opening/closing switches 56 and determines whether the door-type viewing window 44 is opened or closed.

First, if it is determined that the door-opening/closing sensing signal indicates a specific logical state (i.e., the closed state of the door-type viewing window 44) and the temperature in the hatching chamber 32 is lower than the reference hatching temperature value, the CPU 78 drives the electric heater 66 and the air circulation fan 68. Then, the electric heater 66 heats air, and the air circulation fan 68 causes the air heated by the electric heater 66 and moisture generated through vaporization of water stored in the water-storing part 24 to be introduced into the hatching chamber 32 through the circulation passage 42. The air and moisture introduced into the hatching chamber 32 circulate while passing through the vent holes 38 and the water-storing part 24 to the air circulation fan 68, so that the hatching chamber 32 can be maintained at the reference hatching temperature (e.g., 38° C.) and proper humidity (e.g., 60%). The vaporization of water occurs as the water is vaporized due to the air passing through the water-storing part 24.

On the contrary, if it is determined that the door-opening/closing sensing signal from the opening/closing switches 56 does not indicate the specific logical state (i.e., indicates the opened state of the door-type viewing window 44), the CPU 78 drives only the electric heater 66 and the buzzer 74 so that air in the hatching chamber 32 can be heated and the user or observer can be informed through lighting (or flickering) of the symbol 110 of the display unit 76 and a warning sound issued from the buzzer 74 that the door-type viewing window 44 is opened. In this case, since the air circulation fan 68 is not driven, forcible introduction of external cold air into the hatching chamber 32 is prevented and thus the temperature in the hatching chamber 32 is not rapidly lowered. On the other hand, since the air in the hatching chamber 32 is heated by the electric heater 66, the hatching chamber 32 can be maintained at the reference hatching temperature. Consequently, the CPU 78, which responds to the door-opening/closing sensing signal from the opening/closing switches 56 during the hatching period, minimizes introduction of external cold air and also causes the air in the hatching chamber 32 to be heated by the electric heater 66, thereby enabling the hatching chamber 32 to be maintained at the reference hatching temperature even the opened state of the door-type viewing window 44. As a result, it is possible to prevent a hatching egg undergoing a hatching process from being dead due to external cold air. Further, if the door-type viewing window 44 is opened during the hatching period, the CPU 78 prevents the egg-turning operation and the timer's count for reducing a remaining hatching period from being performed while the door-type viewing window 44 is opened. Furthermore, the CPU 78 enables indication of the fact that the viewing window 44 is opened, on the display unit 76.

To fill the water-storing part 24 with water during the hatching period, the CPU 78 periodically compares a moisture sensing signal from the fluid quantity sensor 58 with a lower limit reference value corresponding to a lower limit water quantity (hereinafter, referred to as a “lower limit water value”) to determine whether water lacks. If the moisture sensing signal is smaller than the lower limit water value (i.e., if the water-storing part 24 contains a small amount of water), the CPU 78 drives the buzzer 74 and the display unit 76 so that the buzzer 74 can issue a warning sound and the water replenishment warning symbol 140 of the display unit 76 can be lighted or flickered, thereby informing the user or observer of the state of water shortage. Then, in response to the warning sound from the buzzer 74 and the lighting or flickering of the water shortage symbol 140 on the display unit 76, which indicate the water shortage, the user or observer replenishes the water-storing part 24 with water through the water-feeding cap 40.

The CPU 78 drives the motor 70 included in the egg-turning device 80 in a periodic manner (e.g., every three hours) for a period of time from the beginning of hatching of hatching eggs to three days before completion of the hatching so that the hatching eggs seated in the hatching egg-seating recesses 34 within the hatching chamber 32 can be rotated by 90 degrees. The period during which the periodic egg-turning (egg-rolling) operation is performed may be shortened or prolonged according to the kind of hatching egg. Further, the time interval of the egg-turning (egg-rolling) operation may be controlled to be shortened or prolonged according to the kind of hatching egg. To recognize the time interval of the egg-hatching operation and the period during which the periodic egg-turning operation is performed, the CPU 78 depends on count information from the timer. When the motor 70 is operated, the rotational force of the motor 70 is transmitted to the rotating rollers 82 via the driving gear 90 provided on the rotational shaft of the motor, the driven gears 88 and the count gears 86, which cooperate with the driving gear 90, and the pivoting shafts 84 provided to the respective count gears 86. As the rotating rollers 82 are rotated with the rotational force, the hatching eggs that are seated in the hatching egg-seating recesses 34 and in contact with the rotating rollers 82 are rotated by 90 degrees.

To detect whether the hatching eggs undergoing the hatching process are alive or dead, the CPU 78 drives the infrared light-emitting units 62 so that the infrared light-emitting units 62 can transmit modulated infrared signals to the infrared light-receiving units 64 through the hatching eggs in the hatching chamber 32. Furthermore, the CPU 78 is received information on the amounts of the infrared signals transmitted through the hatching eggs from the infrared light-receiving units 64. At this time, a signal for the information on the transmitted amounts of the infrared signals, which is received by the CPU 78, is a signal obtained by amplifying and filtering the infrared signals received by the infrared light-receiving units 64. Then, the CPU 78 determines whether the hatching eggs undergoing the hatching process are alive or dead, based on changes in the transmitted amounts of the infrared signals. The amounts of the infrared signals transmitted through the hatching eggs are gradually reduced as the hatching of the hatching eggs proceeds. The reason why the transmitted amounts of the infrared signals are reduced is that blood vessels and the heart are produced as the hatching of the hatching eggs proceeds and then blood streams in the blood vessels and heartbeat absorb, diffract or scatter the infrared signals. Therefore, if there is gradual reduction in the transmitted amount of an infrared signal, the CPU 78 determines that a corresponding hatching egg is alive. On the other hand, if there is no variation in the transmitted amount of the infrared signal, the CPU determines that the hatching egg is dead. The CPU 78 controls the display unit 76 based on information on the determination as to whether the hatching eggs are alive or dead, so that the survival-indicating symbol 150 can be lighted or put out, thereby informing an observer of whether the hatching eggs are alive or dead. In addition, the CPU 78 detects the number and positions of hatching eggs undergoing the hatching process, based on variations in the transmitted amount of the infrared signals, and then lights the hatching egg symbols 130 corresponding to the detected positions of the hatching eggs, thereby indicating the number of hatching eggs that will be hatched or are undergoing the hatching process, and the positions of the hatching eggs that are undergoing the hatching process.

### INDUSTRIAL APPLICABILITY

In the hatching apparatus for learners according to the embodiment of the present invention, the hatching chamber for defining a hatching space can be viewed through the viewing window so that a hatching process of a hatching egg can be observed. Further, in the hatching apparatus for learners according to the embodiment of the present invention, it is possible to detect the number of hatching eggs undergoing a hatching process and whether the hatching eggs are alive or dead, and to inform the detected results, thereby maximizing effects on observation of hatching of the hatching eggs.

In the hatching apparatus for learners according to the embodiment of the present invention, a hatching egg undergoing a hatching process is periodically turned (rolled) to improve a hatching rate of a hatching egg. Moreover, in the hatching apparatus for learners according to the embodiment of the present invention, temperature and humidity required for hatching of a hatching egg are consistently maintained to more improve a hatching rate of a hatching egg. In addition, in the hatching apparatus for learners according to the embodiment of the present invention, hatching temperature is maintained even when the hatching space is opened during hatching of a hatching egg, thereby preventing the hatching egg from being dead due to external cold air.

1. A hatching apparatus for learners, comprising:
a hatching chamber defining a hatching space suitable for accommodation of a hatching egg and having a viewing window;
a hatching control means for controlling a hatching condition in the hatching chamber;
an egg-turning device for turning the hatching egg seated within the hatching chamber; and
a control unit for controlling the egg-turning device and the hatching control means to consistently maintain the hatching condition and to periodically drive the egg-turning device.

2. The apparatus as claimed in claim 1, wherein the egg-turning device comprises:
a roller provided to be rotatable in contact with the hatching egg seated in the hatching chamber; and
a motor for rotating the roller.

3. The apparatus as claimed in claim 2, wherein the egg-turning device further comprises a power transmission unit for transmitting a rotational force generated by the motor to the roller.

4. The apparatus as claimed in claim 1, further comprising a display unit for displaying the hatching condition of the hatching egg under control of the control unit.

5. The apparatus as claimed in claim 4, further comprising an input device for sending information on the kind of hatching egg to be hatched from a user to the control unit.

6. The apparatus as claimed in claim 4, further comprising a state-detecting unit for detecting the state of the hatching egg undergoing a hatching process and providing the detected state to the control unit,
wherein the display unit displays the detected state of the hatching egg under the control of the control unit.

7. The apparatus as claimed in claim 4, further comprising a lamp for illuminating the interior of the hatching chamber under the control of the control unit.

8. The apparatus as claimed in claim 4, wherein the hatching chamber comprises:
a hatching egg-seating recess having a curved surface suitable for seating of the hatching egg therein; and
a through-hole formed at the center of the hatching egg-seating recess so that a portion of the roller can be exposed therethrough.

9. The apparatus as claimed in claim 4, wherein the hatching control means comprises:
a temperature sensor for detecting temperature in the hatching chamber and providing the detected temperature to the control unit;
an electric heater operated under the control of the control unit;
a water-storing part for storing water for use in adjusting humidity in the hatching chamber; and
a fan operated under the control of the control unit to vaporize the water stored in the water-storing part and to introduce the vaporized moisture and air heated by the electric heater into the hatching chamber

10. The apparatus as claimed in claim 9, further comprising a fluid quantity sensor for detecting the quantity of the water stored in the water-storing part and providing the detected quantity of the water to the control unit,
wherein the control unit controls a water replenishment request symbol on the display unit, based on the quantity of the water detected by the fluid quantity sensor.

11. The apparatus as claimed in claim 9, further comprising an opening/closing switch performing switching according to opening or closing of the viewing window,
wherein the control unit controls the electric heater and a viewing window-opening/closing symbol on the display unit in response to the switched state of the opening/closing switch.
